(19) United States
(12) Patent Application Publication
(10) Pub. No.: US 2003/0051002 A1
(43) Pub. Date: Mar. 13, 2003

(54) Method of connecting to a remote computer

(76) Inventors: Douglas P. Bogia, Hillsboro, OR (US); Kevin Bross, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/952,667

(22) Filed: Sep. 13, 2001

(51) Int. Cl. G06F 15/16

(52) U.S. Cl. 709/218; 709/227

(57) ABSTRACT

A method of connecting a remote computer to a network comprises receiving a request to access the remote computer, automatically sending a callback request to the remote computer in response to the access request, and establishing a connection between the remote computer and the network. In one embodiment, the method allows data stored on a remote computer to be accessed on demand from a network, such as the Internet, an Intranet, or other wide area network.

### 1. FIELD

The described invention relates to the field of networking. In particular, the invention relates to a method of connecting to a remote computer.

### 2. BACKGROUND

A remote computer, i.e., a computer that is not connected to the Internet at all times, may store data, such as but not limited to: pictures, documents, audio files, video files, e-mail, and other types of data. The remote computer is not connected to the Internet at all times, typically, to avoid paying Internet Service Provider (ISP) fees and/or telecommunications charges. However, it is useful for there to be a way for the network to signal the remote computer when there is a request for data stored on the remote computer.

One way to signal the remote computer is through a call back mechanism, which results in the remote computer connecting to the Internet on demand. One implementation is to provide users with an access number for the remote computer. A user calls the access number, allows the phone to ring a certain number of times, and then hangs up. This activates the call back mechanism, and the remote computer, in response, connects to the Internet.

This solution allows a remote computer to connect to the Internet using a static IP address that is already known by the user. Static IP addresses, however, are more scarce and generally more expensive than dynamic IP addresses. This solution also lacks a way to authenticate that the caller has permission to initiate the call back mechanism that leads to establishing the Internet connection.

### BRIEF DESCRIPTION OF THE DRAWINGS

FIG. 1 is an example structure showing a remote computer connected to a network, such as the Internet.

FIG. 2 is a flowchart showing one embodiment of accessing data on a remote computer from the viewpoint of a network client.

FIG. 3 is a flowchart showing one embodiment of accessing data on a remote computer from the viewpoint of the remote computer.

### DETAILED DESCRIPTION

A method of connecting a remote computer to a network comprises receiving a request to access the remote computer, automatically sending a callback request to the remote computer in response to the access request, and establishing a connection between the remote computer and the network. In one embodiment, the method allows data stored on a remote computer to be accessed on demand from a network, such as the Internet, an Intranet, or other wide area network. In one embodiment, web pages are used to present the data stored on the remote computer. The data may include audio, video, graphic, or other types of data. In another embodiment, file transfer protocol (FTP), virtual private network (VPN) and other types of accesses are allowed with the remote computer or with one of the clients of the remote computer.

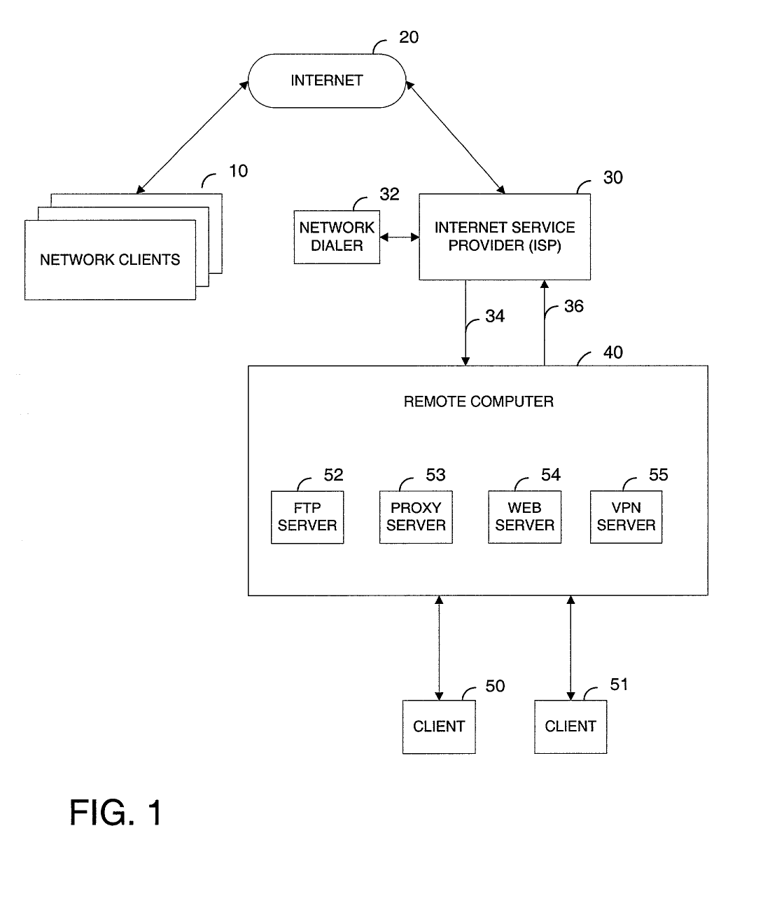

FIG. 1 is an example structure showing a remote computer 40 connected to a network 20, such as the Internet. Various network clients 10, such as servers or individual users, are connected to the network. Although network 20 is hereinafter described in terms of an Internet connection, the same concepts may be extended to other networks such as an Intranet or wide area network.

In one embodiment, the remote computer 40 connects to the Internet 20 through an Internet Service Provider (ISP) 30. Various clients 50, 51 connect to the Internet 20 via the remote computer 40 and the ISP 30. In one embodiment, various servers such as FTP server 52, proxy server 53, web server 54, and/or Virtual Private Network (VPN) server 55 are included in remote computer 40.

In one embodiment, the remote computer 40 connects to the Internet when one of its clients or servers 50-55 needs the connection, or when one of the network clients 10 wants to access data on the remote computer 40. In one embodiment, when one of the network clients 10 wants to access data on the remote computer 40, but the remote computer 40 is not connected to the Internet, then a network dialer 32 is used to notify the remote computer 40 of the access request by sending a callback request 34 to the remote computer 40.

The callback request 34 may be sent via various methods. For example, in one embodiment, the network dialer 32 may send a (wireless) page to the remote computer. In another embodiment, the network dialer calls the remote computer 40 via a phone line and allows the phone connection to ring a predetermined number of times before disconnecting. (In this case, the remote computer 40 does not “pick up” to establish the connection.) In one embodiment, the network dialer 32 is controlled by the Internet Service Provider (ISP) 30, however other components of the network desiring connection to the remote computer 40 may signal the network dialer 32 to initiate the callback request 34.

In another embodiment, the remote computer 40 has caller ID and is configured to only respond to calls from predetermined in-bound phone numbers. Therefore, the ISP 30 may send a callback request 34 to the remote computer 40 by dialing the remote computer 40 and then hanging up. In yet another embodiment, the ISP 30 calls the remote computer 40, and the remote computer 40 answers the phone and looks for a predetermined “handshake” protocol to authenticate the connection request.

In yet another embodiment, the callback request 34 from the ISP 30 to the remote computer 40 is achieved via a wire protocol. For example, a DSL or cable modem connection may be used to signal the remote computer, even though an IP address may not yet have been assigned to the remote computer.

After receiving the callback request 34, the remote computer establishes a connection 36 with the Internet 20 via the ISP 30. In one embodiment, the remote computer calls into the Internet 20 via a dial up connection (analog modem or ISDN). In another embodiment, the remote computer re-establishes a connection to the Internet 20 using a Digital Subscriber Line (DSL) or cable modem connection. This may involve accessing data on the Internet 20 to make sure that the remote computer 40 has a valid IP address, or any other method for waking up the DSL or cable modem connection.

In this manner the remote computer 40 only need be connected to the Internet 20 when data is actively being communicated between the remote computer 40 and the Internet 20. A timeout mechanism may be used to disconnect the remote computer 40 from the Internet 20 when no data is being exchanged. In the case of a DSL or cable modem connection, a timeout mechanism may release the dynamic IP address while not in use.

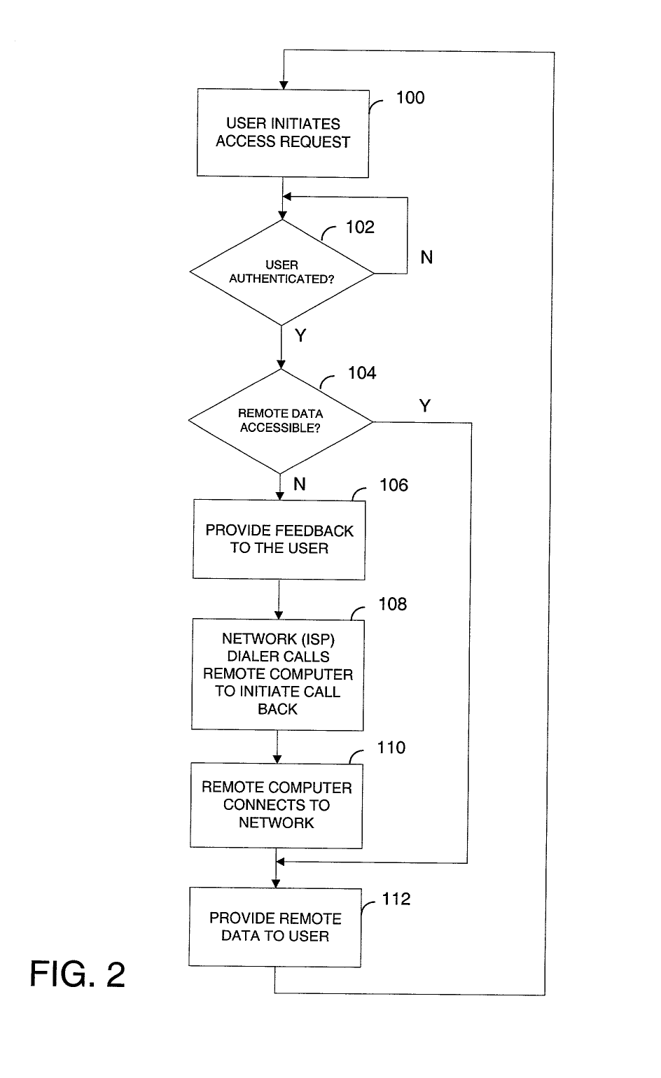

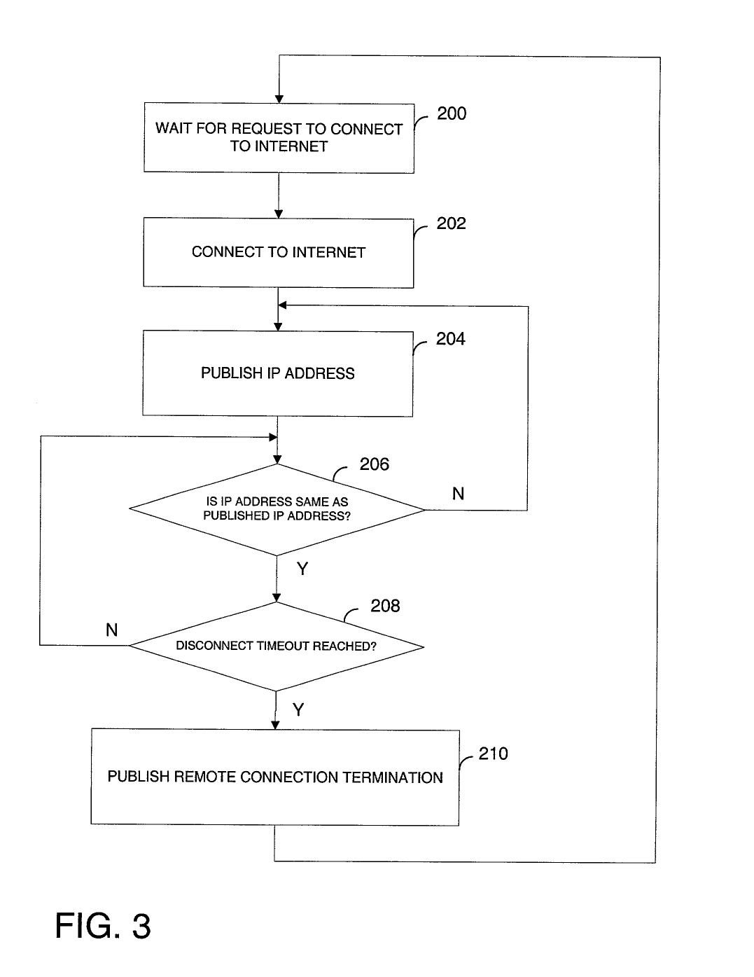

This architecture allows large amounts of data to be stored locally on the remote computer 40 instead of having to be uploaded to a server that is normally connected to the Internet (“an Internet server”), such as an ISP server. Only a minimal amount of data stored on an ISP server, for example, is used to provide a gateway to the data stored locally on the remote computer 40 as will be described with respect to FIGS. 2 and 3. This avoids the costs associated with renting large amounts of storage space on one or more Internet servers.

FIG. 2 is a flowchart showing one embodiment of accessing data on a remote computer from the viewpoint of a network client 10. At block 100, a user (operating through a network client) initiates an access request of the remote computer. The access request may be initiated in various ways. The remote computer's ISP receives the access request, and in response, sends a callback request to the remote computer, as will be described with respect to FIG. 3. In one embodiment, an access request is generated when a user attempts to access a remote IP address or file. In another embodiment, the user sends an email requesting access to the remote computer. In another embodiment, the user attempts to access a first web page associated with data stored on the remote computer 40 (“remote data”). For example, the user may type in a specific URL (Uniform Resource Locator) associated with the remote data using a browser application. As an example, this may be a home web page of a site that is primarily hosted on the remote computer.

In one embodiment, only a minimal amount of data associated with the remote data is stored on an ISP server or an Internet server to allow connection to the remote computer 40. Once the remote computer 40 connects to the Internet, a network client 10 has access to the remote data. This access may include not only web page data, but also, e.g., in the case of a VPN connection, may include access to printers, email, databases, and other services normally available on an Intranet. For example, in one embodiment, only one or two home web pages associated with the remote data are stored on an ISP server or an Internet server. The home web pages may include a script for managing the connection to the remote computer 40.

At block 102, an optional authentication process is initiated to allow access to only users authorized to have access to the remote data. For example, the user may be requested to provide a username and password, which is then compared to a database that may be stored on a local server or on the remote computer. In one embodiment, a Secure Sockets Layer (SSL) is used to authenticate the user. If the user authentication fails, the process flow stays at block 102. Once the user is authenticated, then the process flow continues at block 104.

At block 104, if the remote data is accessible, i.e., the remote computer is currently connected to the Internet, then process flow continues at block 112, and access to the remote data is provided to the user. If the remote data is not accessible, then the user is optionally provided feedback about connecting to the remote computer 40 (block 106). In one embodiment, an intermediate web page is presented to the user (block 106), and a script is run waiting for a dynamic IP address to be provided, as will be described in more detail with respect to FIG. 3. The user may need to perform some action on the intermediate web page, such as clicking a button, to continue with the remote data access. In another embodiment, the connection process is automatic and transparent to the user.

At block 108, the network dialer 32 calls the remote computer 40 to initiate a call back from the remote computer 40. In response to the call, the remote computer connects to the Internet (block 110). The remote computer provides its dynamic IP address as will be described with respect to FIG. 3. In one embodiment, a script running on the intermediate web page uses the dynamic IP address to access the remote computer, and access to the remote data is provided to the user (block 112). It should be noted that some of the process blocks 102-110 may be transparent to the user on the network client. For example, cookies may be employed to authenticate the user without prompting, and depending on the type and speed of the connection, the callback and connection may be quick.

FIG. 3 is a flowchart showing one embodiment of accessing data on a remote computer 40 from the viewpoint of the remote computer. At block 200, the remote computer waits for a callback request 34 by the Internet for the remote computer 40 to connect to the Internet 20. In one embodiment, the callback request is automatically sent by the ISP in response to the ISP receiving the access request from a user, as was described with respect to FIG. 2. Of course, the waiting may be done as a background task or interrupt driven task while the computer performs other tasks in the foreground. After the callback request 34 to connect to the Internet 20 is received, the remote computer 40 connects to the Internet 20, at block 202.

At block 204, the remote computer publishes the remote computer's dynamic IP address. In one embodiment, the IP address is published to an intermediate web page located on a predetermined web page having a static IP address, such as one stored on a server of the ISP. The intermediate web page may be used as the entrance for remote data accesses that require connection to the remote computer 40. Once the dynamic IP address of the remote computer is known, a script may be used to access the remote computer using the stored dynamic IP address. The script may be implemented in javascript, VB script, PERL, or other scripting languages. Active Server Page (ASP) and Personal Home Page (PHP) are examples of additional scripts that may be used on the server for putting the dynamic IP address on the web page.

In an alternate embodiment, the IP address may be published via other wired or wireless modes of communication, such as email.

In one embodiment, the ISP may employ Dynamic Host Configuration Protocol (DHCP) addressing which may re-assign the dynamic IP address of the remote computer. At block 206, the remote computer periodically checks that the IP address that it published is the same as its current dynamic IP address. If the remote computer receives a new IP address, it re-publishes the new IP address (looping back to block 204).

If the IP address published is the same as the remote computer's current IP address, then the remote computer checks whether a disconnect timeout has been reached (block 208). At block 208, if the disconnect timeout has not been reached then process flow continues back to block 206.

In one embodiment, if the disconnect timeout has been reached then the process continues at block 210, at which a notification is sent indicating that the remote connection is terminating. In one embodiment, this is accomplished by the intermediate web page being re-published to include a button or other mechanism to allow a user to initiate a subsequent connection to the remote computer 40. In one embodiment, the intermediate web page may redirect the user to a second web page stored on the remote computer. In an alternate embodiment, the remote computer may issue its connection termination notification via email or other wired or wireless modes of communication.

From block 210, process flow returns to block 200.

In another embodiment, the DHCP client knows when it gets a new IP address. Instead of using a polling mechanism, the remote computer, by hooking into the DHCP program, is able to automatically publish the IP address whenever the DHCP address changes.

Thus, a method of accessing a data stored on a remote computer is disclosed. The disclosed method may be used in conjunction with a Virtual Private Network (VPN) to allow a secure access to a remote computer on demand. This allows secure communications over the Internet, and can be used not only for HTTP, but F?P, TELNET, and other communication protocols. However, the specific embodiments and methods described herein are merely illustrative. For example, although the connection to the remote computer was described responsive to an access to a web page, the connection alternatively could be made in response to an email or other type of request sent to the ISP or network. Numerous modifications in form and detail may be made without departing from the scope of the invention as claimed below. The invention is limited only by the scope of the appended claims.

What is claimed is:

1. A method of establishing a connection between a remote computer and a network comprising:
receiving an access request to access the remote computer;
sending a callback request to the remote computer;
establishing a connection between the remote computer and the network in response to the callback request;
publishing a network address to the network; and
using the network address to connect to the remote computer or through the remote computer to a client computer that is networked to the remote computer.

2. The method of claim 1 further comprising:
re-publishing the network address to the network when the network address of the remote computer changes.

3. The method of claim 2 wherein the network address is a dynamic IP address.

4. The method of claim 2 wherein the network address is a static IP address.

5. The method of claim 1 further comprising:
displaying a web page stored on the remote computer.

6. The method of claim 1 further comprising:
performing FTP accesses between the remote computer and the network.

7. The method of claim 1 further comprising:
performing VPN accesses between the remote computer and the network.

8. The method of claim 1 wherein sending the callback request to the remote computer further comprises:
initiating a phone call from the network to the remote computer to prompt a call back from the remote computer.

9. The method of claim 1 wherein sending the callback request to the remote computer further comprises:
using a paging service to prompt a call back from the remote computer.

10. The method of claim 1 wherein sending the callback request to the remote computer further comprises:
signaling the remote computer via a wire protocol to prompt a call back from the remote computer.

11. A method of coupling a remote computer to a network comprising:
receiving an access request to access the remote computer;
automatically sending a callback request to the remote computer in response to the access request; and
establishing a connection between the remote computer and the network.

12. The method of claim 11 wherein automatically sending the callback request to the remote computer further comprises:
initiating a phone call from the network to the remote computer to prompt a call back from the remote computer.

13. The method of claim 11 wherein automatically sending the callback request to the remote computer further comprises:
using a paging service to prompt a call back from the remote computer.

14. The method of claim 11 wherein automatically sending the callback request to the remote computer further comprises:
sending a signal to a modem coupled to the remote computer to prompt a call back from the remote computer.

15. The method of claim 11 wherein automatically sending the callback request to the remote computer further comprises:
signaling the remote computer via a wire protocol to prompt a call back from the remote computer.

16. The method of claim 11 wherein establishing the connection between the remote computer and the network further comprises:
re-establishing a DSL connection to the network.

17. The method of claim 11 wherein establishing the connection between the remote computer and the network further comprises:
re-establishing a cable modem connection to the network.

18. The method of claim 11 wherein the access request is generated in response to a user accessing a web page.

19. The method of claim 11 wherein the access request is generated in response to receiving an email.

20. The method of claim 11 wherein the access request is generated in response to an access to a remote IP address or file.

21. The method of claim 11 further comprising
determining that the remote computer is not connected to the network prior to automatically sending the callback request.

22. The method of claim 11, wherein the network is part of a worldwide Internet.

23. The method of claim 11 further comprising:
authenticating the access request via a security protocol prior to automatically sending the callback request.

24. A method of connecting to a network comprising:
receiving a callback request from the network;
establishing a connection with the network; and
publishing a network address to the network.

25. The method of claim 24 wherein the network address is a dynamic IP address.

26. The method of claim 24 wherein the network address is a static IP address.

27. The method of claim 24 wherein the callback request is received via a phone call.

28. The method of claim 24 wherein the callback request is received via a paging service.

29. The method of claim 24 wherein the callback request is received via a wire protocol.

30. The method of claim 24 further comprising:
re-publishing the network address to the network when the network address of the remote computer changes.

31. The method of claim 24, wherein establishing a connection with the network further comprises:
re-establishing a DSL connection to the network.

32. The method of claim 24, wherein establishing a connection with the network further comprises:
re-establishing a cable modem connection to the network.

33. The method of claim 24 further comprising:
authenticating the callback request prior to establishing the connection with the network.

34. A method of connecting a remote computer to a network comprising:
publishing a network address of a remote computer to the network; and
updating the network address when the network address changes;
providing data to a user accessing the remote computer via the network address.

35. The method of claim 34 wherein the network address is a dynamic IP address.

36. The method of claim 35 wherein the publishing is done to a predetermined web site.

37. An article comprising a computer-readable medium which stores computer-executable instructions, the instructions causing a computer to:
determine that a remote computer is not connected to a network;
automatically initiate a callback mechanism in the remote computer responsive to a user accessing a first web page stored on the network; and
establish a connection between the network and the remote computer.

38. The article of claim 37, wherein the article further comprises instructions to:
redirect the user to a remote web page stored on the remote computer.

39. The article of claim 38, wherein the article further comprises instructions to:
wait for the remote computer to establish the connection between the network and the remote computer.

40. The article of claim 38, wherein the article further comprises instructions to:
re-establish a DSL or cable modem connection between the network and the remote computer.

41. An article comprising a computer-readable medium which stores computer-executable instructions, the instructions causing a computer to:
publish a network address of a remote computer to the network; and
update the network address when the network address changes.

42. The article of claim 41, wherein the article further comprises instructions to:
provide data to a user accessing the remote computer via the network address.

43. The article of claim 42, wherein the network address is a dynamic IP address.
